(19) United States
(12) Patent Application Publication
(10) Pub. No.: US 2009/0120652 A1
(43) Pub. Date: May 14, 2009

(54) FIRE HOSE NOZZLE HOLDING APPARATUS

(76) Inventor: Martin Lawrence Dala, (US)

Correspondence Address: Craig Miller, 642 Via Umbroso, San Clemente, CA, 92672, US

(21) Appl. No.: 11/938,789

(22) Filed: Nov. 13, 2007

(51) Int. Cl. A62C 39/00

(52) U.S. Cl. 169/51

(57) ABSTRACT

The primary objective of the present invention is to produce a fire hose nozzle holding apparatus that can easily store a fire hose nozzle such that the nozzle is protected from damage that occurs in transport. Another objective of the present invention is to enable a person to quickly obtain the fire hose nozzle from the fire hose nozzle holding apparatus such that the fire hose nozzle can be quickly attached to a fire hose.

### TECHNICAL FIELD

The present invention is generally related to a fire hose nozzle holding apparatus that secures the nozzle of a fire hose such that it is not damaged in transport and that it expedites the deployment of a fire hose and nozzle.

### SUMMARY

The primary objective of the present invention is to produce a fire hose nozzle holding apparatus that can easily store a fire hose nozzle such that the nozzle is protected from damage that occurs in transport. Another objective of the present invention is to enable the fire hose nozzle to be externally mounted to an engine while enabling the fire hose nozzle to remain attached to the fire hose thereby allowing quick deployment.

### DESCRIPTION OF DRAWINGS

The above and other features and advantages of the present invention will be better understood with reference to the following detailed description when considered in conjunction with the accompanying drawings in which:

FIG. 1 is a side view of the present invention;

FIG. 2 is a sectional view of the present invention

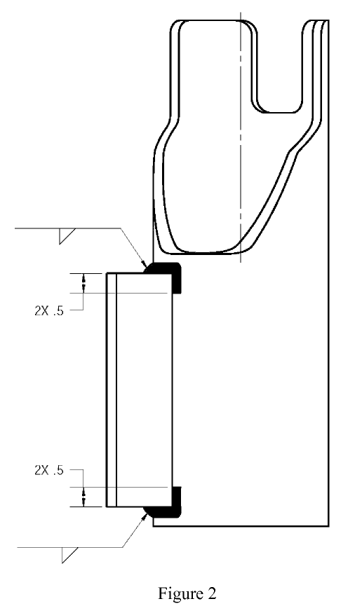

### BACKGROUND

The present invention relates to securing a fire hose nozzle on a fire vehicle like a fire truck or what is commonly referred to in the art has an engine. In the event of a fire the fire department is notified of the fire and the location of the fire. The fire department then deploys an engine and personnel to respond to the reported fire. An engine has the ability to store water, transport water and the ability to connect to municipal water systems referred to as fire hydrants or drafting sites, which can be lakes, ponds, rivers, or swimming pools near the location of the fire. An engine also carries fire hoses and fire hose nozzles. An engine is capable of dispersing water at a high flow rate which is carried to the fire with the use of fire hoses which are also carried by an engine. It is generally known in the art that the larger diameter fire hose will carry a higher flow rate than smaller diameter hose. It is not uncommon for an engine to disperse water at the rate of 100 to 1000 gallons per minute depending on the diameter of the fire hose. This high flow rate of water dispersion needs to be controlled so that fire personnel can choose where they wish to place the water. The control of the high flow rate of water is performed by use of a fire hose nozzle which is attached to the fire hose at the opposite end of an engine. A fire hose nozzles is also carried to the fire location by the engine and is built to match the fire hose diameter and it is generally accepted by the industry that a fire hose nozzle that is built to match a larger fire hose diameter is more expensive than a fire hose nozzle that is built to match a smaller fire hose diameter. Fire hose nozzles that are built to match a larger fire hose can cost more than $1,500 dollars. Fire hose nozzles are also built with a handled shut off valve for easy control of the high flow rate of water. It is common in the art for an engine to carry many of fire hose nozzles that are built to match a larger fire hose.

In the event of a fire the fire department readies the engine by ensuring that the engine has water and the fire hoses and fire hose nozzles are operational and kept ready for use. Engine manufactures are also design and manufacture engines such that equipment is easily assessable and ready for quick use. In fact it is common for the engines to be made such that fire hoses can be stored externally on a bed often referenced to in the art as a transfer bed. Although fire engine manufactures have designed engines to store fire hoses they have not provided external storage for fire hose nozzles. In fact it is common for fire engines to be designed a manufactures such that the fire hose nozzle is stored in a cabinet inside the engine commonly referred in the art as the engineer's cabinet. Storing fire hose nozzles in the engineer's cabinet has proven to cause such a delay in attaching the fire hose nozzle to the fire hose that most fire department store fire hose nozzles with the fire hoses in the transfer bed. Storing fire hose nozzles in the transfer bed enables fire personnel to attached the fire hose nozzle to the fire hose the transfer bed does not provide adequate protection for the fire hose nozzle. In fact, it is common for the fire hose nozzle to be damaged due to the movement of the engine during transport. Furthermore, the fire hose nozzle can fall in between the fire hoses stored within the transfer bed such that when the fire hose is deployed the fire hose nozzle falls to the ground and causes additional damage.

It is the intention of the present invention to resolve the deficiencies related the current methods of storing the fire hose nozzle. Furthermore it is the intention of the present invention to enable external storage of a fire hose nozzle which enables the quick attachment of the fire hose nozzle to the fire hose.

### DETAIL DESCRIPTION

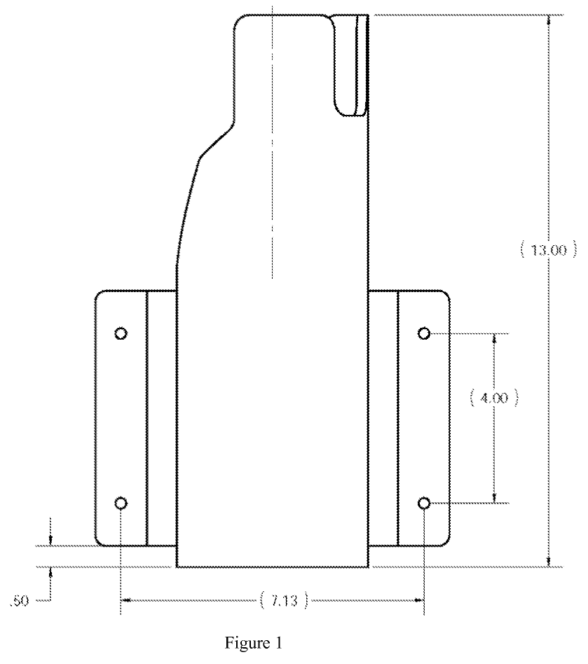

In one embodiment of the present invention, a fire hose nozzle holding apparatus is provided such that the fire hose nozzle holding apparatus can be mounted eternally on the engine and is smartly configured to hold a fire hose nozzle. In the primary embodiment of the present invention the fire hose nozzle holding apparatus is made in out of aluminum but it is easily conceivable by one knowledgeable in the art to make the fire hose nozzle apparatus out of many different types of materials. In the primary embodiment as identified in FIG. 1 provides a fire hose nozzle holding apparatus which is mountable on the outside of the engine and is smartly configured to hold a fire hose. The fire hose nozzle holding apparatus includes a cylindrical unit where the circumference of the cylindrical unit can range between 16 cm and 72 cm. As shown in FIG. 1 the circumference is 31.90 cm. Furthermore in the preferred embodiment of the present invention and as shown in FIG. 1 the cylindrical unit has a large cutout and a small cutout which is located on the receiving end of the fire hose nozzle holding apparatus where the receiving end is the end of the cylindrical unit which the nozzle first passes through when inserting the fire hose nozzle into the fire hose nozzle holding apparatus. The size of the large cutout ranges from 20 percent to 70 percent of the total circumference of the fire hose nozzle holding apparatus and the small cutout ranges from 5 percent to 20 percent of the total circumference of the fire hose nozzle holding apparatus. In the embodiment of the present invention as shown in FIG. 1 the circumference is 31.90 cm, the circumference of the large cutout is 19.14 cm and the circumference of the small cutout is 3.8 cm where the large cutout is 60 percent of the total circumference and the small cutout is 12 percent of the total circumference. Furthermore the special relationship between the large cutout and the small cutout is shown in the FIG. 1 where the center of the large cutout is directly opposite of the center of the small cutout.

The purpose of the large cutout and the small cutout is additionally innovative since they provide support for the fire hose nozzle such that when the fire hose nozzle is placed in the fire hose nozzle holding apparatus the shut off valve can be inserted into the area of the large cutout while at the same time the handle of the fire hose nozzle can be inserted into the area of the small cutout. As further shown in FIG. 1 the fire hose nozzle holding apparatus includes a bracket that is smartly welded onto the cylindrical unit such that the cylindrical unit can be conveniently externally mounted on an engine despite the configuration of the engine. The bracket includes 2 mounting holes which reside on side of the bracket that is externally mounted on the engine. When the fire hose nozzle holding apparatus has been welded to the bracket the 2 mounting holes enable screws to pass through the bracket thereby enabling the fire hose nozzle holding apparatus to be externally mounted to the engine.

In practice of the present invention and prior to responding to a fire the fire department would mount the fire hose nozzle holding apparatus externally on the engine and preferably near the transom bed such that the fire hose nozzle holding apparatus can be holding a fire hose nozzle while the fire hose is attached to the fire hose nozzle. Therefore when responding to a fire the fire personnel do not need to locate the fire hose nozzle. The present invention also reduces the delay of responding to a fire which occurs in the traditional method of storing fire hose nozzles in the engineer cabinet due to the delay caused by fire personnel retrieving the fire hose nozzle mounted in the engineer cabinet and attaching the fire hose nozzle to the fire hose. In the present invention the fire personnel would remove the fire hose nozzle from the fire hose nozzle holding apparatus.

What is claimed is:

1. A fire hose nozzle holding apparatus comprising:
a bracket;
a cylindrical unit;
a large cutout;
a small cutout; and
a bracket where the bracket is smartly welded onto the cylindrical unit such that the cylindrical unit can be externally mounted on an engine.

2. A fire hose nozzle holding apparatus of claim 1, wherein a large cutout and a small cutout is located on the receiving end of the fire hose nozzle.

3. A fire hose nozzle holding apparatus of claim 1, wherein the size of the large cutout ranges from 20 percent to 70 percent of the total circumference of the fire hose nozzle holding apparatus.

4. A fire hose nozzle holding apparatus of claim 1, wherein the size of the small cutout ranges from 5 percent to 20 percent of the circumference of the fire hose nozzle holding apparatus.

5. A fire hose nozzle holding apparatus of claim 1, wherein circumference of the cylindrical unit can range between 16 cm and 72 cm.
